(19) United States
(12) Patent Application Publication
(10) Pub. No.: US 2011/0185842 A1
(43) Pub. Date: Aug. 4, 2011

(54) FLYWHEEL LOCKING TOOL KIT

(75) Inventors: Michael L. Whitehead, Clarinda, IA (US); Steven J. Carr, Boonville, NY (US)

(73) Assignee: Lisle Corporation, Clarinda, IA (US)

(21) Appl. No.: 12/717,422

(22) Filed: Mar. 4, 2010

Related U.S. Application Data
(60) Provisional application No. 61/301,090, filed on Feb. 3, 2010.

(51) Int. Cl. G05G 5/06

(52) U.S. Cl. 74/527

(57) ABSTRACT

A flywheel locking tool kit comprises unitary body blocks designed to fit through and respectively compatible with the opening of a bell housing of a transmission so that teeth provided on one sector of the tool may be engaged with the flywheel teeth and projections and elements of the opposite end of the tool may be engaged with the sides or edges of the opening through the bell housing to retain the tool in a fixed, desired position.

### A RELATED APPLICATION

This is a utility application incorporating by reference and claiming priority to previously filed and co-pending provisional patent application Ser. No. 61/301,090 filed Feb. 3, 2010 entitled Flywheel Locking Tool Kit.

### BACKGROUND OF THE INVENTION

In a principal aspect the present invention relates to a tool which is designed to engage and lock a flywheel associated with a vehicle transmission and, more particularly, to a kit with tools which is useful for locking a flywheel of a vehicle transmission in order to allow the harmonic balancer bolt of the engine to be removed. The vehicle repair operation involves locking of the flywheel followed by the removal of the harmonic balancer bolt so as to enable replacement of a water pump or the crank shaft reluctor wheel.

Heretofore, tools have been offered designed to hold a flywheel in a locked position particularly on various General Motors engines having the 6.6 L Duramax engine. A tool designed to effect such locking has been marketed by Kent-Moore Inc. and is identified as the J-44643 flywheel holding tool. Utilization of this tool is described at the domain site www.motoralldata.com. While the referenced tool is useful, such use requires that the automobile engine starter motor be removed prior to locking of the flywheel. Utilization of the Kent-Moore flywheel locking tool J-44643 thus requires bolting of the tool into position following removal of the automobile starter motor. The bolts that held the starter motor in place are then used to hold the locking tool in place. Removal and installation of the starter motor takes approximately 1.2 hours and make the repair operation time consuming and expensive.

The 6.6 L Duramax engine is used on various Dodge pick up truck models as well as with General Motors vehicles. The various Dodge vehicles utilizing the engine vary from a light duty to a heavy duty vehicle. The vehicles employ distinctly designed and manufactured flywheel covers and associated component parts. Thus, it has been determined that the design of the flywheel and its housing necessitate the availability of at least two distinctly constructed flywheel locking tools.

Thus there is a need for a protocol as well as a tool or kit of tools which will enable locking of the flywheel more quickly and more efficiently than the prior art protocol using the described Kent-Moore tool.

### SUMMARY OF THE INVENTION

Briefly the present invention comprises a kit which includes at least two embodiments of a tool useful for the locking of a flywheel in a fixed, non-rotatable position by insertion of the tool through the bell housing for a vehicle transmission and, more particularly, through an opening found in the bell housing normally covered with a rubber plug or sheet metal plate. The tool includes projecting teeth which are sized to engage the flywheel within the housing and also includes specially designed elements or features that enable retention of the tool within the opening by appropriately engaging the sides of the opening in the bell housing. The tools in the kit each include a integral unitary body with an array of projecting teeth designed to engage the flywheel teeth of the flywheel within the bell housing and various body elements designed to engage with the sides of the opening in the bell housing to prevent movement of the tool and thus movement of the engaged flywheel upon placement of the tool through the opening in the bell housing.

Thus it is an object to the invention to provide a kit of tools useful for engaging and locking flywheels associated with various automatic transmissions to thereby lock the flywheel in a non-rotatable position without undesirable removal of other engine components.

It is a further object of the invention to provide a flywheel engagement tool which comprises a unitary body that includes an array of locking teeth an other elements or features which enable the tool to be positioned through an opening in the bell housing of a vehicle automatic transmission so as to engage and hold the flywheel in a locked position in combination with the bell housing.

Yet another object of the invention is to provide tools crafted to be useful for holding a flywheel in a non-rotatable or locked position within a bell housing wherein the tool is light weight, comprised of a unitary body, adequately rugged, easy to use and inexpensive.

These and other objects, advantages and features of the invention will be set forth in a detailed description which follows.

### BRIEF DESCRIPTION OF THE DRAWING

In the detailed description which follows, reference will be made to the drawing comprised of the following figures:

FIGS. 1 through 4 are a series of figures depicting a first embodiment of the invention;

FIG. 1 is an isometric view of a first embodiment;

FIG. 2 is a bottom plan view of the embodiment of FIG. 1;

FIG. 3 is an end view of the embodiment of FIGS. 1 and 2;

FIG. 4 is a side view of the embodiment of FIG. 3;

FIGS. 5-8 comprise a depiction of a second embodiment of the invention and in particular:

FIG. 5 is an isometric view of the embodiment of the invention;

FIG. 6 is a bottom plan view of the embodiment of FIG. 5;

FIG. 7 is an end view of the embodiment of FIG. 6;

FIG. 8 is a side view of the embodiment of FIG. 7;

FIG. 9 is an isometric view of the first embodiment of the tool depicted insertion through an opening in a bell housing to engage the teeth of the flywheel;

FIG. 10 is an isometric view depicting the tool of FIG. 9 before insertion through a rectangular opening in a bell housing of a transmission for engagement with the teeth of a flywheel;

FIG. 11 is an isometric view illustrating the tool of FIG. 9 upon insertion through the opening in a bell housing;

FIG. 12 is an isometric drawing depicting the use of the tool of FIGS. 5-8 inserted through an opening in a bell housing to engage the teeth of a flywheel; and

FIG. 13 is an isometric view depicting the placement of the tool of FIGS. 5-8 into engagement with the teeth of a flywheel within a bell housing upon insertion through an opening in the transmission housing.

### DESCRIPTION OF EMBODIMENTS OF THE INVENTION

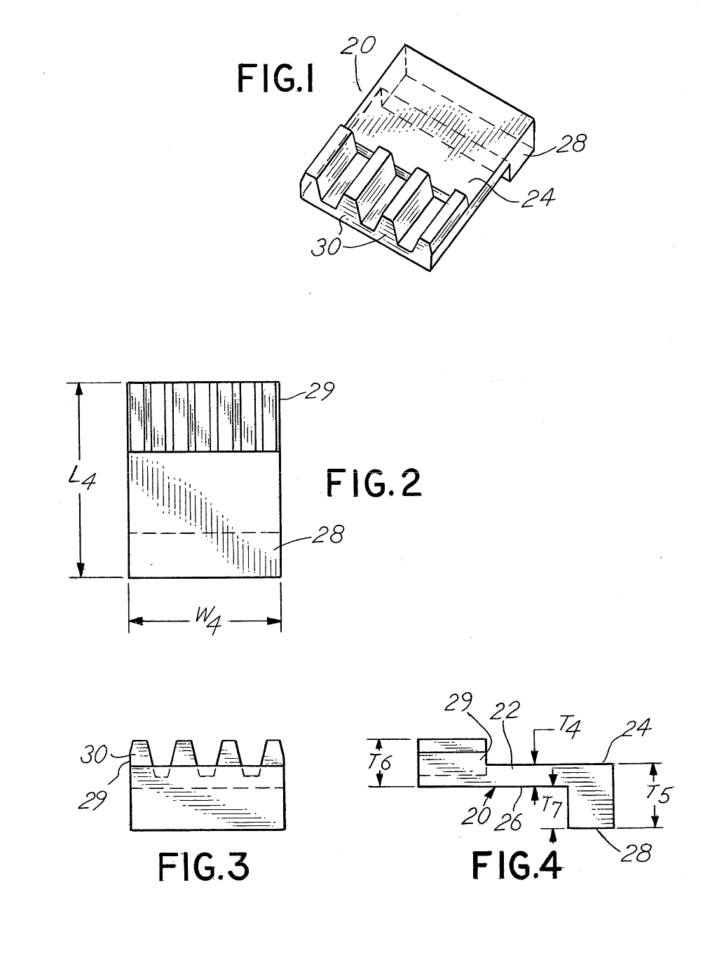

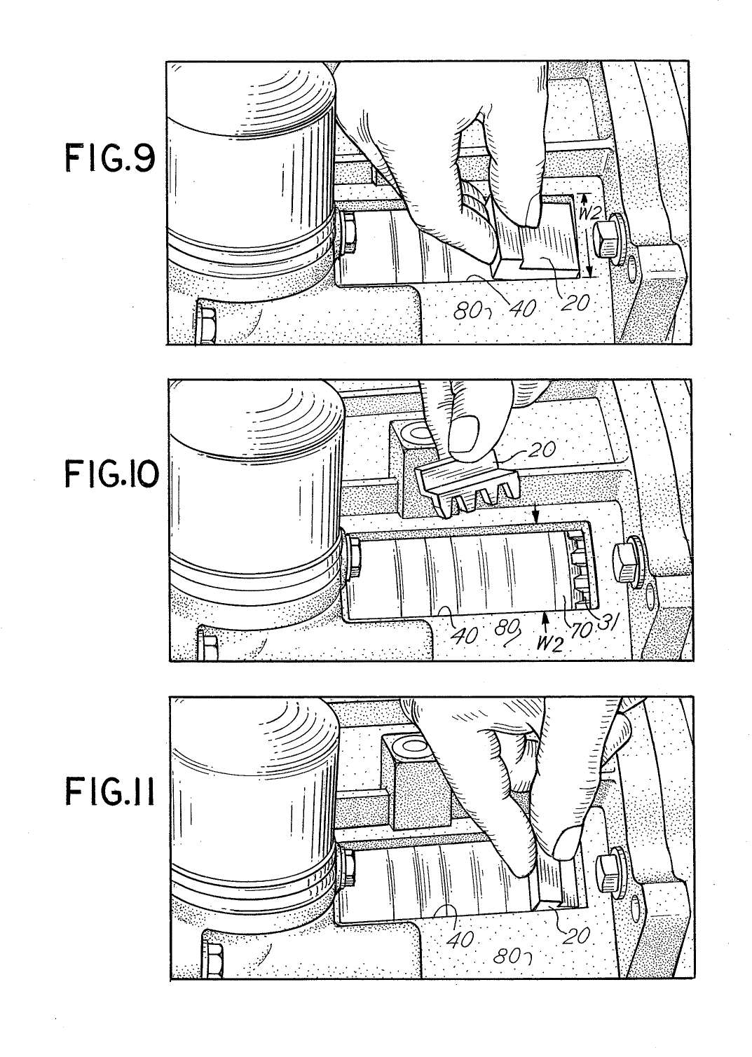

FIGS. 1-4 and 9-11 illustrate a first embodiment of the invention. Specifically a uniform width dimension and uniform length dimension, unitary, generally rectangular body block 20 has a length L₄ and a width W₄. The body block 20 includes a first generally rectangular, integral, parallelepiped mid-section 22. The body block 20 includes a bottom surface 26 and a top surface 24. The top and bottom surfaces 24, 26 are flat and planar and define a uniform depth or thickness T₄. A second rectangular parallelepiped, integral end section 28 projects transversely with respect to the surface 24. The end section has a uniform depth or thickness T₅. The thickness T₅ is greater than the thickness T₄.

A third generally rectangular parallelepiped opposite end section 29 includes a plurality of integral gear teeth 30 and projects in the opposite, transverse direction of the second end section 28. The third end section 29 has a thickness T₆ including the extent of teeth 30. The third section 29 projects outwardly from the first middle or intermediate section 22 in a direction opposite to that of the second or end section 28 and thus projects in a manner such that the teeth 30 extend outwardly from the surface 24. The teeth 30 of the third section 29 are generally parallel and include a crown and groove parallel to the length dimension L₄. The teeth 30 are equally spaced, uniformly sized and designed to engage with compatible teeth associated with a flywheel 70 retained within a bell housing 80 of an automatic transmission. Thus as shown in FIGS. 9-12, the tool of FIGS. 1-4 is insertable into a generally rectangular opening 40 in a transmission bell 80 having a width is slightly greater than the width of the tool W₄. Thus the tool with the width of W₄ is inserted into the opening 40 and oriented so that the teeth 30 project and are maintained within the housing or bell 80 so as to engage and lock with the teeth of a flywheel to prevent rotation of the flywheel 70. Also, the dimension T₆ which is the difference between dimensions T₄ and T₅ is preferably slightly greater than the thickness of the wall of bell 80.

The thickness T₄ of the middle section 22 of the tool or block 20 is slightly greater than the thickness of the wall of the bell housing 80. This enables the tool to be appropriately positioned for retention by the second end section 28 of the tool to engage the side of opening 40 of the bell housing 80 while at the same time fitting within the interior of the bell housing 80 so as to engage the teeth 30 of the tool with the teeth 31 of the flywheel 70 retained within the bell housing 80. Of course, with the embodiment depicted is unnecessary to remove the water pump or any other feature associated with the engine in order to effect locking of the flywheel.

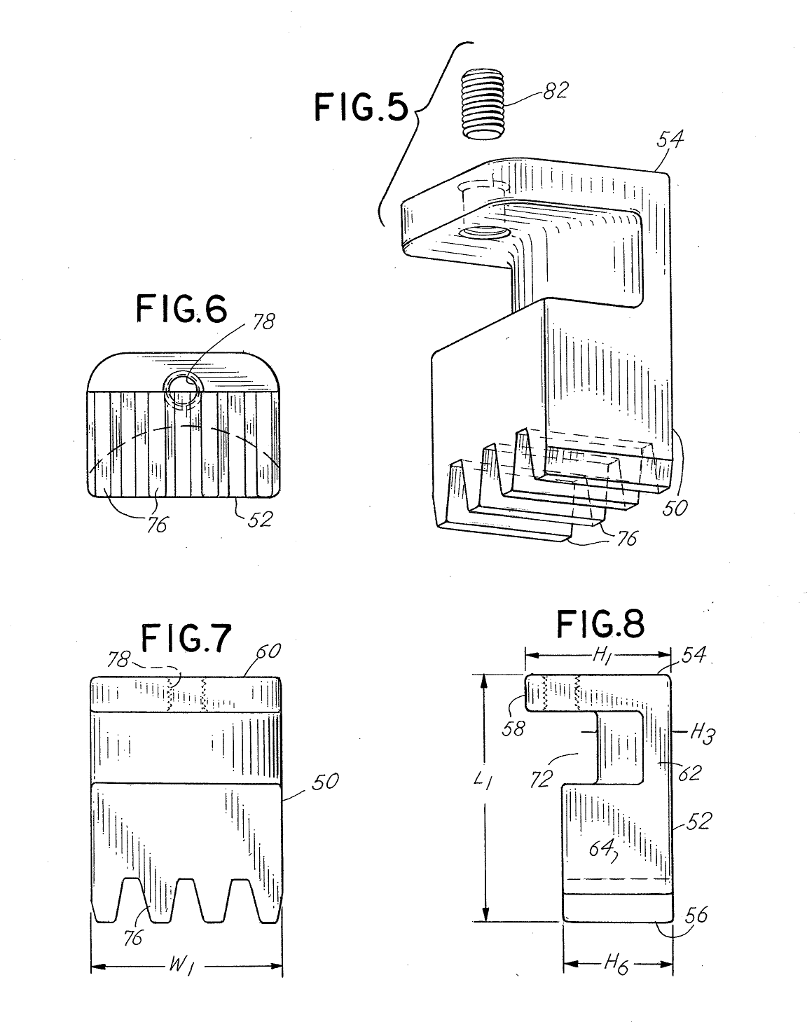

FIGS. 5-8 and 12-14 illustrate a second embodiment of the tool. Referring initially to FIGS. 5-8, the flywheel locking tool comprises a unitary body block 50 which includes a generally rectangular flat planar back side surface 52 having a width W₁ and a length L₁, a top side edge 54 and a bottom side edge 56. The body block 50 further includes a first or top end section 58 which projects transversely from the back side surface 52 by dimension H₁. The first end section 58 comprises a top side 60 of the body block 50, and includes an edge coterminous with the top side edge 54 of the body block 50.

The body block 50 further includes a second middle section 62 and a third bottom end section 64. The middle section 62 and the bottom end section 64 project transversely from the back side surface 52 in the same direction as the first section 58. The second or middle section 62 has a maximum height dimension H₃ which is less than the height dimension H₁ of the first section 58. It is also less than the height dimension H₆ of the bottom end section 64. Thus a slot 72 is formed between the first end section 58 and the third bottom end section 64. The bottom end section 64 includes a series of generally parallel, spaced gear teeth 76 which are generally parallel to each other, equally sized and equally spaced. The teeth project transversely in the direction of the length of the embodiment; namely, in the direction of the length L₁. The top end section includes a threaded opening 78 through which a fastener' such as a screw or bolt 82 may be inserted to hold the tool in position on an opening of a bell housing.

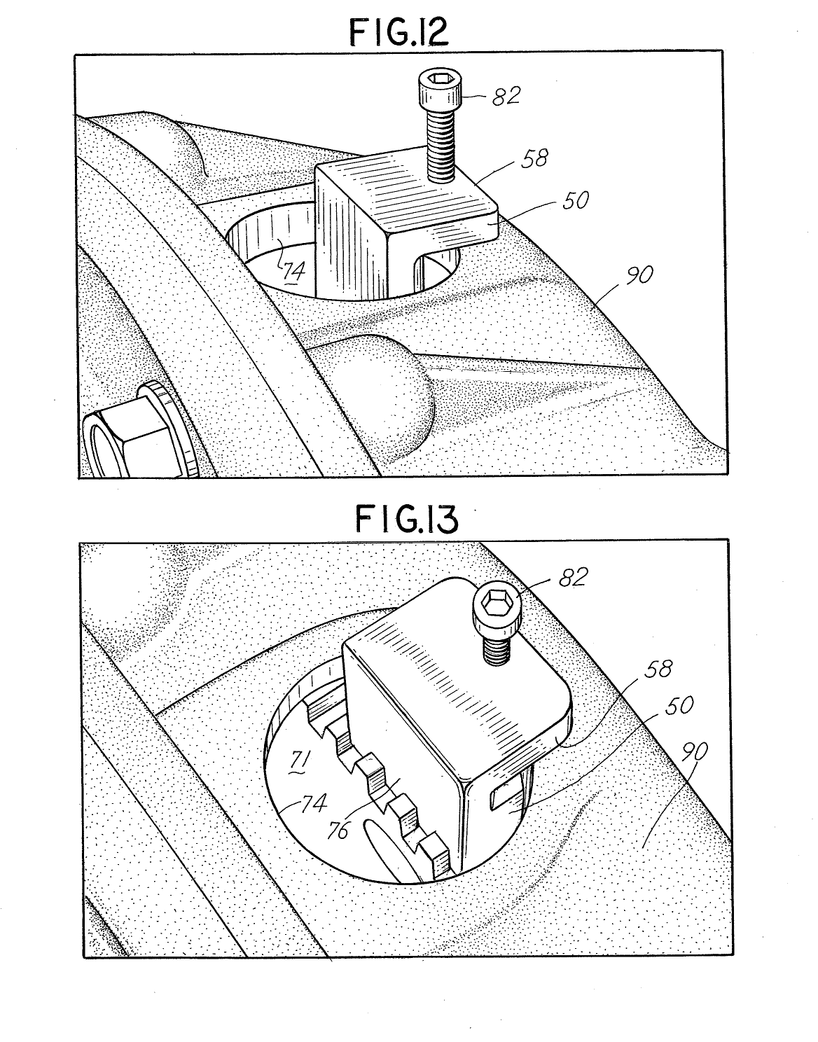

As shown in FIGS. 12-13 the tool of FIGS. 5-8 may be inserted through an opening 74 in a bell housing 90 with slot 72 dimensioned to approximate the thickness of the bell housing 90 so that the top or first section 58 may fit over the outside surface of the bell housing 90 and the third section 64 may be inserted into the bell housing 90 to enable the teeth 76 to engage the teeth of a flywheel 71 therein. The fastener 82 may be tightened to retain the tool in engagement with the teeth of the flywheel 71. Thus, the teeth 76 are compatible with the teeth 71 of the flywheel located in the housing 90. The first section 58 is fitted on the outside of the bell housing 90. The slot 72 is fitted against the opening 74 of the bell housing 90, and the third section 64 with the gear teeth 76 is maintained within the interior of the bell housing 90 so that the teeth 76 will engage the flywheel teeth 71.

Typically the tools described are provided in a kit wherein both of the tools are made available to a mechanic or automobile repair specialist so that the appropriate tool may be utilized from the kit and, in addition, a socket may be provided in combination with the described tools of the kit to enable removal or replacement of a harmonic balancer bolt, for example.

Variations in the construction, the size and dimensions, teeth configuration and the other features of the tools may occur depending upon a particular flywheel construction and bell housing construction for which the tool is required. Dimensional changes, changes in the sizes of opening in the bell housing including the dimension and shape may be accommodated by minor adjustments and appropriate adjustments to the dimensions of the described embodiments. Thus, while there has been set forth a description of embodiments of the invention, the invention is to be limited only by the following claims and equivalents thereof.

1. A flywheel locking tool comprising:
a unitary body block including a generally rectangular, flat, planar back side surface having a width W₁ and a length L₁; a top side edge with a dimension W₁ and a bottom side edge with a dimension W₁
said body block further including a first top end section projecting transversely from the back side surface by a dimension H₁, said first end section comprising a top side of the body block with an edge coterminous with said top side edge;
said body block further including a second middle section and a third bottom end section, said second and third sections projecting transversely from the back side surface in the same direction as the first section;
said second section projecting a dimension H₅ less than H₁ and said third section projecting a dimension H₆ greater than H₅ to thereby form a slot between said first and third sections;
said third section including a series of generally parallel, spaced gear teeth projecting transversely outwardly from the back side surface in the direction of length L₁ and each tooth having a crown and groove generally parallel to and the length of the bottom side edge;
whereby said tool is insertable, in part, through an opening in a transmission bell housing, with said gear teeth engaging compatible teeth of a flywheel located in said housing and said first and third sections of said tool fitted over opposite outside and inside surfaces respectively of said bell housing and said second section is positioned to retain said tool engaged with said housing and said flywheel in a generally immovable position.

2. The tool of claim 1 further including a screw fastener located through an opening in said first section to engage and held said tool generally fixed to said housing.

3. The tool of claim 1 where in said second section includes an arcuate surface intermediate the first and second sections.

4. The tool of claim 1 wherein said teeth are equally sized and spaced.

5. A flywheel locking tool comprising:
a uniform width dimension and uniform length dimension unitary generally rectangular body block having a width W₄ and length L₄ with a first rectangular parallelepiped integral end section having a uniform thickness T₅, an intermediate rectangular parallelepiped middle section having a top planar surface, a bottom planar surface and a generally uniform thickness T₄ less than T₅, and a third generally rectangular parallelepiped opposite end section including a plurality of integral gear teeth, having a generally uniform thickness T₆ incorporating said teeth,
said first end section projecting outwardly in a first direction coplanar to and relative to said bottom planar surface of said second intermediate section;
said third end section projecting outwardly in a direction coplanar to and relative to said top planar surface opposite to that of said first end section projection, said teeth of said third section generally parallel and including a crown and groove parallel to said length dimension;
whereby said tool is insertable into a generally rectangular opening in a transmission bell housing having a width W₂ generally equal to the width W₄ of said tool with said width W₄ of said tool oriented in alignment with the width W₂ of said opening and said gear teeth in locking engagement with compatible teeth of a flywheel located in said housing to thereby engage and hold said flywheel in a generally locked position with said tool wedged in said bell housing opening.

6. The tool of claim 5 wherein said teeth are equally sized and spaced.

7. The tool of claim 5 wherein the thickness T₅ of said first section is greater than the thickness of the wall of said bell housing and is equal to the thickness T₄ plus a thickness T₇ for positioning in opposition to a wall of said bell housing.

8. A repair kit comprising the tool of claim 1 and the tool of claim 5.
